(19) United States
(12) Patent Application Publication
(10) Pub. No.: US 2022/0331992 A1
(43) Pub. Date: Oct. 20, 2022

(54) ROBOTIC GRIPPER WITH OFFSET GRIPPING ELEMENTS

(71) Applicant: ATS Automation Tooling Systems Inc., Cambridge (CA)

(72) Inventors: Sandeep Gurav, Cambridge (CA); Daniel Kostecke, Cambridge (CA)

(21) Appl. No.: 17/707,954

(22) Filed: Mar. 30, 2022

Related U.S. Application Data
(60) Provisional application No. 63/167,943, filed on Mar. 30, 2021.

(51) Int. Cl. B25J 15/02; B25J 15/00

(52) U.S. Cl. CPC B25J 15/0253; B25J 15/0042

(57) ABSTRACT

A robotic gripper configured to mount to a robotic arm is described herein. The robotic gripper includes a base configured to mount to the robotic arm and spin about an axis of the base. The robotic gripper also includes at least two gripping elements coupled to the base. Each gripping element extends from the base in a direction parallel to the axis of the base and is movable relative to the base between an open position and a closed position to grasp an object. A first gripping element of the at least two gripping elements defines a first element axis laterally spaced from the axis of the base by a first distance. At least one other gripping element defines another element axis that is laterally spaced from the axis of the base by a second distance that is smaller than the first distance.

### CROSS-REFERENCE

The present application claims the benefit of U.S. Provisional Patent Application No. 63/167,943 entitled “robotic Gripper with Offset Gripping Elements” filed on Mar. 30, 2021, the contents of which are hereby incorporated by reference in their entirety.

### FIELD

This disclosure relates generally to grippers used in robotics and other applications and, in particular, to robotic grippers with offset gripping elements.

### BACKGROUND

Robotic end effectors, such as robotic grippers, are provided at the distal ends of robotic manipulators, such as robotic arms, to grasp and/or manipulate objects. Although there are many robotic grippers currently in the market, they often have one or more drawbacks that interfere with their usability.

For instance, several robotic grippers currently in the market are configured so that gripping elements, or fingers, thereof extend from a base of the gripper to reach for an object at an angle other than 90 degrees. This may cause it to be difficult for the gripper to grasp large objects.

Further, in some cases where it is important for a gripper to grasp a large or heavy object, the fingers of the grippers are too thick to grasp an object when the object is positioned near to another object, or, for example, a wall or partition such as when the object is stored in a tote.

Accordingly, there is a need for new grippers used in robotics and other applications.

### SUMMARY

In accordance with one broad aspect, a robotic gripper configured to mount to a robotic arm is described herein. The robotic gripper includes a base configured to mount to the robotic arm and spin about an axis of the base. The robotic gripper also includes at least two gripping elements coupled to the base. Each gripping element extends from the base in a direction parallel to the axis of the base and is movable relative to the base between an open position and a closed position to grasp an object. A first gripping element of the at least two gripping elements defines a first element axis laterally spaced from the axis of the base by a first distance. At least one other gripping element defines another element axis that is laterally spaced from the axis of the base by a second distance that is smaller than the first distance.

In at least one embodiment, the at least two gripping elements include two gripping elements, the first gripping element and a second gripping element, the second gripping element defining a second element axis laterally spaced from the axis of the base by a second distance, the second distance being smaller than the first distance.

In at least one embodiment, an outer edge of the base defines a perimeter of the base and, when the first gripping element is in its open position, the first element axis is laterally spaced outwardly beyond the perimeter of the base.

In at least one embodiment, the first element axis and the second element axis are both laterally spaced from the axis of the base on a same side of the gripper.

In at least one embodiment, the first gripping element comprises a first mounting portion configured to mount the first gripping element to the base and a first extending portion extending away from the base, the first extending portion defining the first element axis.

In at least one embodiment, the first extending portion of the first gripping element has a first thickness at a proximal end thereof and a second thickness at a distal end thereof, the second thickness being smaller than the first thickness.

In at least one embodiment, the second gripping element comprises a second mounting portion configured to mount the second gripping element to the base and a second extending portion extending away from the base, the second extending portion defining the second element axis.

In at least one embodiment, the second mounting portion is shaped to receive the first mounting portion when the first gripping element and the second gripping element are each in their closed position.

In at least one embodiment, the second mounting portion of the second gripping element is complementary to the first mounting portion of the first gripping element.

In at least one embodiment, at least one of the gripping elements is wedge-shaped.

In at least one embodiment, each of the gripping elements is configured to move relative to the base in a direction that is perpendicular to the axis of the base of the base.

In at least one embodiment, each of the gripping elements is configured to mount to a bottom surface of the base.

In at least one embodiment, the first gripping element and the second gripping element are configured to move laterally between their respective open and closed positions at a same time.

In at least one embodiment, the axis of the base passes through the base.

In at least one embodiment, the gripper further comprises at least one stabilizer configured to mount to the base and to at least one of the gripping elements to inhibit rotation of the gripping elements relative to the base.

In at least one embodiment, the stabilizer is mounted to a side surface of the base.

In at least one embodiment, the base is configured to spin 360 degrees about the axis of the base.

In at least one embodiment, the base is configured to couple to a standard motion plate for an end effector.

In at least one embodiment, the first gripping element has a first contact surface and the second gripping element has a second contact surface, the first contact surface and the second contact surface being opposed to each other.

In at least one embodiment, at least one of the first and the second contact surfaces has knurling thereon.

In at least one embodiment, both the first and the second contact surfaces have knurling thereon.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a perspective view of a robotic gripper according to at least one embodiment described here.

FIG. 2 is a side view of the robotic gripper of FIG. 1 having gripping elements at their open position.

FIG. 3 is a side view of the robotic gripper of FIG. 1 having gripping elements at their partially open position.

FIG. 4 is a side view of the robotic gripper of FIG. 1 having gripping elements at their closed position.

FIG. 5 is a bottom view of the robotic gripper of FIG. 1 having gripping elements at their open position.

FIG. 6 is a bottom view of the robotic gripper of FIG. 1 having gripping elements at their closed position.

FIG. 7 is a cross-sectional view along the line A-A of the robotic gripper of FIG. 2 showing knurling on the surface of the second gripping element.

FIG. 8 is a side view of the robotic gripper of FIG. 1 grasping an object.

Further aspects and features of the example embodiments described herein will appear from the following description taken together with the accompanying drawings.

### Description of Example Embodiments

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive − or. That is, “X and/or Y” is intended to mean X, Y or X and Y, for example. As a further example, “X, Y, and/or Z” is intended to mean X or Y or Z or any combination thereof. Also, the expression of A, B and C means various combinations including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Recently, there has been a growing interest in developing new robotic grippers with gripping elements.

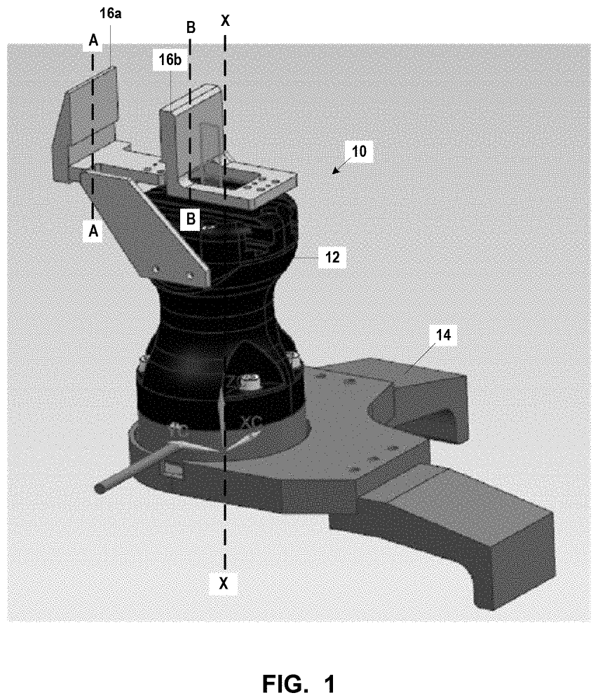

Turning to the figures, FIG. 1 shows an example embodiment of an end effector 10. As is apparent from FIG. 1, the end effector 10 is configured as a robotic gripper. For purposes of convenience, the end effector 10 will be referred to herein as a robotic gripper. Robotic gripper 10 is configured to mount to a robotic arm.

Robotic gripper 10 includes a base 12 that is configured to mount to the robotic arm such as but not limited to the portion of the robotic arm 14 shown in FIG. 1. Base 12 is configured to rotate or revolve relative to the robotic arm 14. For instance, in at least one embodiment, base 12 is configured to rotate about or spin on an axis X-X of the base 12. In at least one embodiment, the axis X-X passes through the base 12. In at least one embodiment, the axis X-X passes through a center of the base 12. It should be understood that base 12 is configured to spin on or rotate about the axis X-X by 360 degrees.

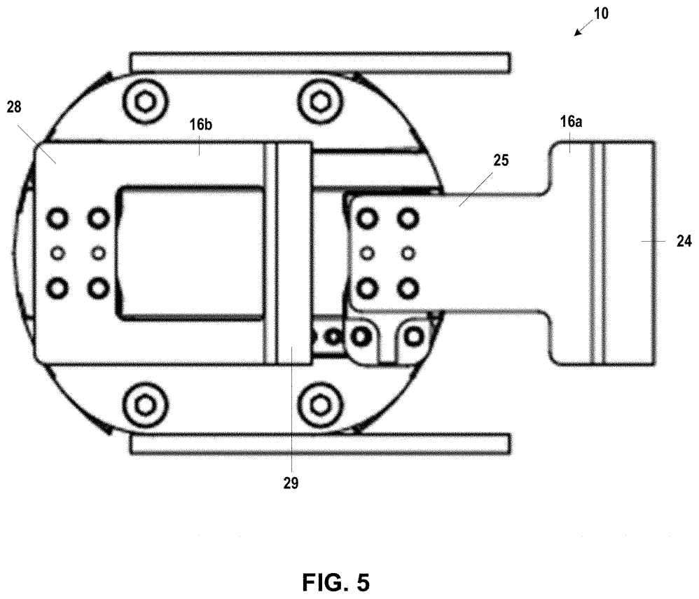

Base 12 has an outer edge 13 that defines a perimeter 15 that surrounds the base. In the embodiment shown in the figures, the perimeter 15 is roughly an oval shape (see FIG. 5).

The robotic gripper 10 also includes at least two opposed gripping elements 16 that are designed to grasp objects. In the embodiment shown in the figures, the robotic gripper 10 includes two gripping elements 16, a first gripping element 16a and a second gripping element 16b.

As shown in FIG. 1, each gripping element 16a, 16b has an elongated paddle-like body that comprises a mounting portion and an extending portion, respectively (described in greater detail below). Generally, the extending portions each extend from their respective mounting portions in a direction that is parallel to the axis X-X if the robotic gripper 10 and travel in a direction that is transverse (e.g. perpendicular) to the axis X-X.

In at least one embodiment, the first gripping element 16a defines a first element axis A-A laterally spaced from the axis X-X of the base 12 by a first distance when the first gripping element is in its open position. In at least one embodiment, the second gripping element 16b defines a second element axis B-B laterally spaced from the axis X-X of the base 12 by a second distance when the first gripping element is in its open position.

In at least one embodiment, the first distance is greater than the second distance.

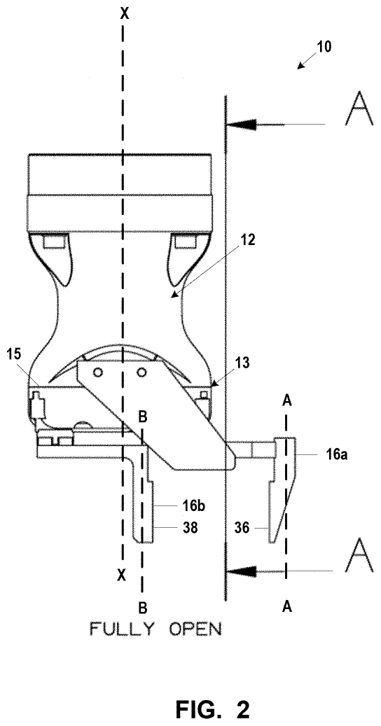

Turning to FIG. 2, shown therein is a side view of the robotic gripper of FIG. 1. In this image, each gripping element 16 of the robotic gripper 10 is at its respective open position. When the gripping elements 16 of the robotic gripper 12 are in their open position, the robotic gripper is able to receive an object therein.

As shown therein, when the first gripping element 16a is in its open position, the first element axis A-A (defined by the first extending portion 20a of the first gripping element 16a) is laterally spaced outwardly beyond the perimeter 15 of the base 13. In at least one embodiment, the first gripping element 16a being laterally spaced beyond perimeter 15 of the base 12 provides for the gripping element 16a to reach behind objects and grasp them, particularly when, for example, other gripping elements may not have been able to fit between the object to be grasped and, for example, a wall or divider of a tote such that object cannot be grasped.

In at least one embodiment, the first element axis A-A and the second element axis B-B are both laterally spaced from the axis X-X on a same side of the gripper. For instance, as shown in FIG. 2, when the first gripping element 16a and the second gripping element 16b are in their respective open position, each of the first gripping element 16a and the second gripping element 16b are positioned on a same side of the axis X-X.

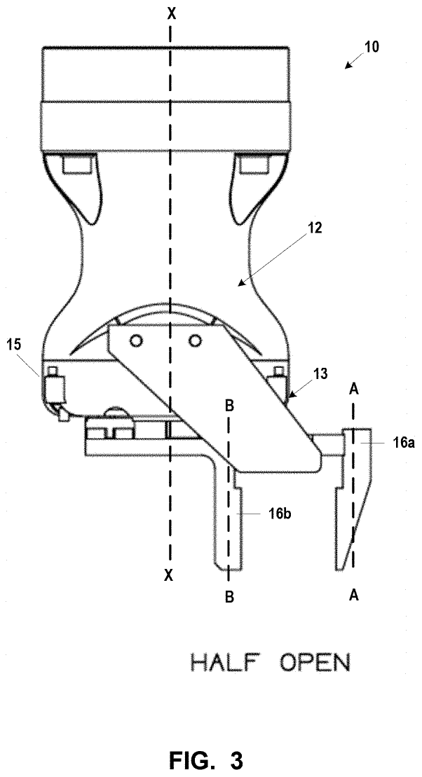

For instance, in another example shown in FIG. 3, when the first gripping element 16a and the second gripping element 16b are in their respective half-open position, each of the first gripping element 16a and the second gripping element 16b are positioned on a same side of the axis X-X.

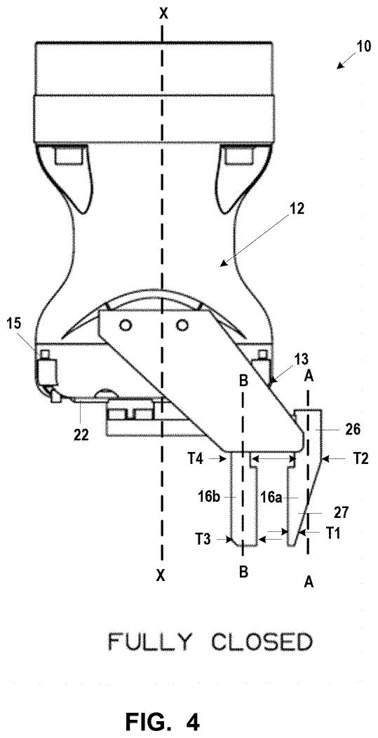

For instance, in another example, shown in FIG. 4, when the first gripping element 16a and the second gripping element 16b are in their respective closed position, each of the first gripping element 16a and the second gripping element 16b are positioned on a same side of the axis X-X.

Turning to FIG. 5, the first gripping element 16a comprises a first mounting portion 22 configured to mount the first gripping element 16a to the base 12 and a first extending portion 24 extending away from the base 12.

In at least one embodiment, the first mounting portion 25 of the first gripping element 16a extends from the first extending portion 24 inwardly towards a center of the base 12. In at least one embodiment, the first mounting portion 25 of the first gripping element 16a is coupled to base 12 to provide for the first mounting portion 25 of the first gripping element 16a to move (e.g. slide) relative to the base 12. In at least one embodiment, the first mounting portion 25 is configured to couple to base 12 to provide for the first gripping element 16a to slide laterally inwardly and outwardly between its closed and open positions. In at least one embodiment, the first mounting portion 25 of the first gripping element 16a provides for the first gripping element 16a to move in a direction that is perpendicular to the axis X-X of the base 12.

In at least one embodiment, first extending portion 24 defines the first element axis A-A (as shown for example in FIGS. 1-4). In at least one embodiment, first extending portion 24 of the first gripping element 16a has a first thickness T1 at a proximal end 26 thereof and a second thickness T2 at a distal end 27 thereof (see FIG. 4). In at least one embodiment, the second thickness T2 is smaller than the first thickness T1. In at least one embodiment, the thickness of first extending portion 24 change linearly along at least a portion of its length, from second thickness T2 to the first thickness T1, between the proximal end 26 and the distal end 27.

Returning to FIG. 5, the second gripping element 16b has a second mounting portion 28 configured to mount the second gripping element 16b to the base 12 (e.g. to a bottom surface 22 of the base 12) and a second extending portion 29 extending away from the base 12.

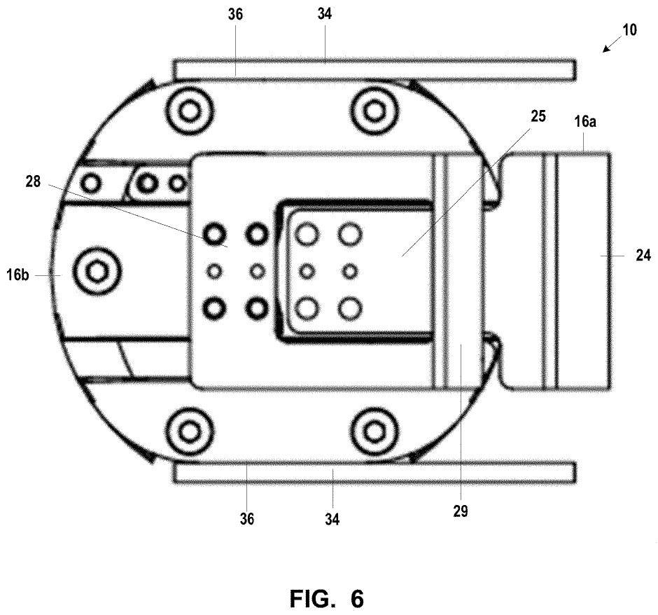

In at least one embodiment, the second mounting portion 28 of the second gripping element 16b extends from the second extending portion 29. In at least one embodiment, second mounting portion 28 extends inwardly towards a center of the base 12 (such as for instance when the second gripping element 16b is in its closed position (see FIG. 6)). In at least one embodiment, second mounting portion 28 extends outwardly from a center of the base 12 (such as for instance when the second gripping element 16b is in its open position (see FIG. 5)). In at least one embodiment, the second mounting portion 28 of the second gripping element 16b is coupled to base 12 to provide for the second gripping element 16b to move (e.g. slide) relative to the base 12. In at least one embodiment, the second mounting portion 28 is configured to couple to base 12 to provide for the second gripping element 16b to slide laterally inwardly and outwardly between its closed and open positions. In at least one embodiment, the second mounting portion 28 of the second gripping element 16b provides for the second gripping element 16b to move in a direction that is perpendicular to the axis X-X of the base 12.

In at least one embodiment, second extending portion 29 of the second gripping element 16b has a first thickness T3 at a proximal end 30 thereof and a second thickness T4 at a distal end 31 thereof. In at least one embodiment, the second thickness T4 is smaller than the first thickness T3. In at least one embodiment, the thickness of first extending portion 24 change linearly along at least a portion of its length, from second thickness T2 to the first thickness T1, between the proximal end 30 and the distal end 31. In at least one embodiment, T3 about equals T4.

In at least one embodiment, the second extending portion 29 defines the second element axis B-B.

In at least one embodiment, the second mounting portion 28 is shaped to receive the first mounting portion 25. For instance, the second mounting portion 28 may be shaped to receive the first mounting portion 25 when the first gripping element 16a and the second gripping element 16b are each in their open position, closed position or therebetween. In at least one embodiment, the first mounting portion 25 and the second mounting portion 28 may be structurally complementary (i.e., fit together; for example such as but not limited to first mounting portion 25 fitting within an opening or aperture in second mounting portion 28).

In at least one embodiment, the first gripping element 16a and the second gripping element 16b are configured to move laterally (e.g. slide) relative to base 12 between their respective open and closed positions simultaneously (e.g. at a same time). In at least one embodiment, the first gripping element 16a and the second gripping element 16b are configured to move laterally (e.g. slide) relative to base 12 independently (e.g. while the other gripping element remains stationary).

In at least one embodiment, robotic gripper 10 further includes at least one stabilizer 34. Stabilizer 34 is configured to mount to the base 12 and to at least one of the gripping elements 16a, 16b to inhibit rotation of at least one of the gripping elements 16a, 16b relative to the base 12. For instance, in at least one embodiment, the stabilizer 34 may be mounted to a side surface 36 of the base 12. In at least one embodiment, gripper 10 may include two stabilizers 34 mounted to opposed side surfaces 36 of the base 12.

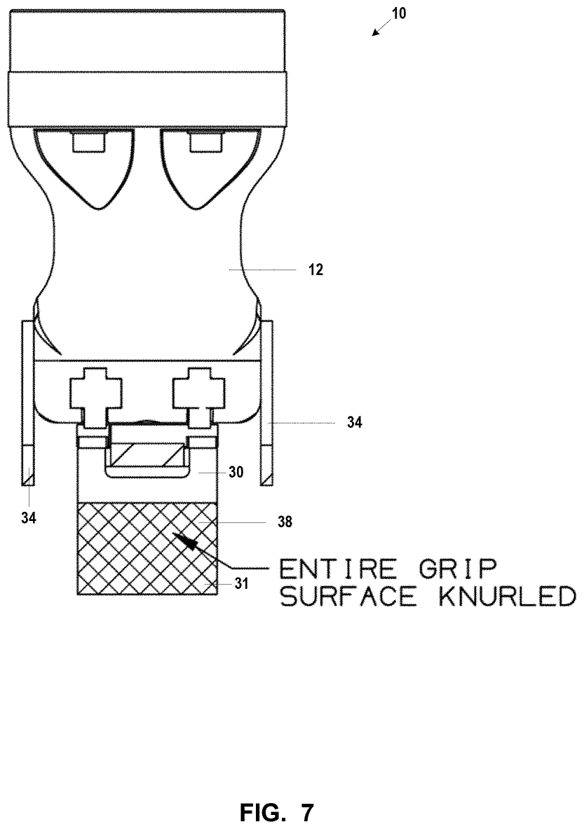

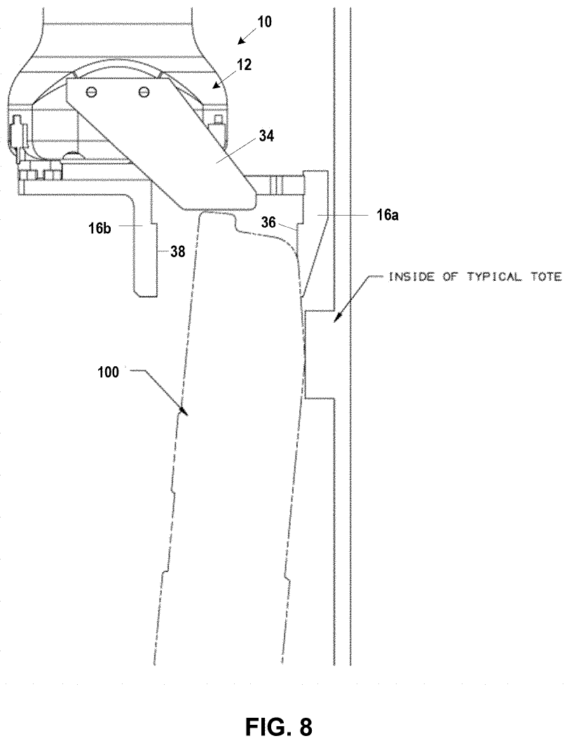

Turning to FIG. 7, shown therein is a cross-section view of the gripper 10 of FIG. 1 along the line A-A shown in FIG. 2. In at least one embodiment, each of the extending portions 24, 29 of the gripping elements 16a, 16b, respectively, have a contact surface 36, 38, respectively. Contact surfaces 36, 36 are opposed to each other and co-operate to contact and grip or grasp an object when it is desired for gripper 10 to grasp the object. FIG. 8 shows one embodiment of gripper 10 being used to grasp an object 100. In at least one embodiment, contact surfaces 36, 38 are shaped as planar surfaces to grasp objects with flat surfaces, such as but not limited to heavy flat surfaces that require a large contact area (e.g. the entire area of the contact surfaces 36, 38 may contact the object, as opposed to grippers that offer contact points). Contact surfaces 36, 38 are positioned at the distal ends 27, 31 of the extending portions 24, 29 of the gripping elements 16a, 16b, respectively. Contact surfaces 36, 38 may protrude inwardly relative to the proximal ends 26, 30 of the extending portions 24, 29, respectively, to inhibit the proximal ends 26, 30 of the extending portions 24, 29 from contacting the object 100 and/or to promote contact between the contact surfaces 36, 38 and the object 100.

In at least one embodiment, at least one of the first and the second contact surfaces 36, 38 has knurling thereon. Herein, the term “knurling” is used to refer to a pattern of straight, angled or crossed lines in the material having teeth of uniform pitch. For instance, the contact surfaces 36, 38 may be metal surfaces and the knurling may refer to a pattern of straight, angled or crossed lines rolled into the material to provide the teeth. In at least one embodiment, the knurling may offer an enhanced gripping surface for the gripper to grasp objects relative to a flat metal surface.

In at least one embodiment, one of surfaces 36, 38 may have knurling thereon. In at least one embodiment, both of surface 36, 38 may have knurling thereon.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A robotic gripper configured to mount to a robotic arm, the robotic gripper comprising:
a base configured to mount to the robotic arm and spin about an axis of the base; and
at least two gripping elements coupled to the base, each gripping element extending from the base in a direction parallel to the axis of the base and movable relative to the base between an open position and a closed position to grasp an object, a first gripping element of the at least two gripping elements defining a first element axis laterally spaced from the axis of the base by a first distance when the first gripping element is in its open position, at least one other gripping element defining another element axis that is laterally spaced from the axis of the base by a second distance that is smaller than the first distance when the at least one other gripping element is in a respective open position.

2. The robotic gripper of claim 1, wherein the at least two gripping elements include two gripping elements, the first gripping element and a second gripping element, the second gripping element defining a second element axis laterally spaced from the axis of the base by a second distance, the second distance being smaller than the first distance.

3. The robotic gripper of claim 2, wherein an outer edge of the base defines a perimeter of the base and, when the first gripping element is in its open position, the first element axis is laterally spaced outwardly beyond the perimeter of the base.

4. The robotic gripper of claim 3, wherein the first element axis and the second element axis are both laterally spaced from the axis of the base on a same side of the gripper.

5. The robotic gripper of claim 2, wherein the first gripping element comprises a first mounting portion configured to mount the first gripping element to the base and a first extending portion extending away from the base, the first extending portion defining the first element axis.

6. The robotic gripper of claim 5, wherein the first extending portion of the first gripping element has a first thickness at a proximal end thereof and a second thickness at a distal end thereof, the second thickness being smaller than the first thickness.

7. The robotic gripper of claim 2, wherein the second gripping element comprises a second mounting portion configured to mount the second gripping element to the base and a second extending portion extending away from the base, the second extending portion defining the second element axis.

8. The robotic gripper of claim 7, wherein the second mounting portion is shaped to receive the first mounting portion when the first gripping element and the second gripping element are each in their closed position.

9. The robotic gripper of claim 8, wherein the second mounting portion of the second gripping element is structurally complementary to the first mounting portion of the first gripping element.

10. The robotic gripper of claim 1, wherein at least one of the gripping elements is wedge-shaped.

11. The robotic gripper of claim 1, wherein each of the gripping elements is configured to move relative to the base in a direction that is perpendicular to the axis of the base.

12. The robotic gripper of claim 1, wherein each of the gripping elements is configured to mount to a bottom surface of the base.

13. The robotic gripper of claim 2, wherein the first gripping element and the second gripping element are configured to move laterally between their respective open and closed positions at a same time.

14. The robotic gripper of claim 1, wherein the axis of the base passes through the base.

15. The robotic gripper of claim 1 further comprising at least one stabilizer configured to mount to the base and to at least one of the gripping elements to inhibit rotation of the gripping elements relative to the base.

16. The robotic gripper of claim 15, wherein the stabilizer is mounted to a side surface of the base.

17. The robotic gripper of claim 1, where in the base is configured to couple to a standard motion plate for an end effector.

18. The robotic gripper of claim 2, wherein the first gripping element has a first contact surface and the second gripping element has a second contact surface, the first contact surface and the second contact surface being opposed to each other.

19. The robotic gripper of claim 18, wherein at least one of the first and the second contact surfaces has knurling thereon.

20. The robotic gripper of claim 18, wherein each of the first and the second contact surfaces has knurling thereon.
